(19) United States
(12) Patent Application Publication
(10) Pub. No.: US 2016/0367445 A1
(43) Pub. Date: Dec. 22, 2016

(54) Music Playing Pacifier Assembly

(71) Applicant: Angel Diaz, Eatontown, NJ (US)

(72) Inventor: Angel Diaz, Eatontown, NJ (US)

(21) Appl. No.: 14/744,305

(22) Filed: Jun. 19, 2015

(51) Int. Cl. A61J 17/00

(52) U.S. Cl. CPC A61J 17/002

(57) ABSTRACT

A music playing pacifier assembly includes a front side, a back side and a perimeter edge. A nipple comprising a resiliently compressible material is attached to and extends away from the front side. A housing is attached to the back side and extends away therefrom. The housing includes a distal end with respect to the back side and a perimeter wall extending between the distal end and the back side. A sound emitter is mounted within the housing. A control circuit is positioned within the housing and is electrically coupled to the sound emitter. An electronic memory is electrically coupled to the control circuit. The electronic memory stores at least one song thereon. The control circuit audibly plays the at least one song with the sound emitter when the control circuit is actuated to a play condition.

### BACKGROUND OF THE DISCLOSURE

### Field of the Disclosure

The disclosure relates to pacifier devices and more particularly pertains to a new pacifier device for soothing a child with music.

### SUMMARY OF THE DISCLOSURE

An embodiment of the disclosure meets the needs presented above by generally comprising a wall has a front side, a back side and a perimeter edge. A nipple comprising a resiliently compressible material is attached to and extends away from the front side. A housing is attached to the back side and extends away therefrom. The housing includes a distal end with respect to the back side and a perimeter wall extending between the distal end and the back side. A sound emitter is mounted within the housing. A control circuit is positioned within the housing and is electrically coupled to the sound emitter. An electronic memory is electrically coupled to the control circuit. The electronic memory stores at least one song thereon. The control circuit audibly plays the at least one song with the sound emitter when the control circuit is actuated to a play condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a rear perspective view of a music playing pacifier assembly according to an embodiment of the disclosure.

FIG. 2 is a side view of an embodiment of the disclosure.

FIG. 3 is a top view of an embodiment of the disclosure.

FIG. 4 is a rear view of an embodiment of the disclosure.

FIG. 5 is a broken side view of an embodiment of the disclosure.

FIG. 6 is a side in-use view of an embodiment of the disclosure.

FIG. 7 is a schematic view of an embodiment of the disclosure.

### DESCRIPTION OF THE PREFERRED EMBODIMENT

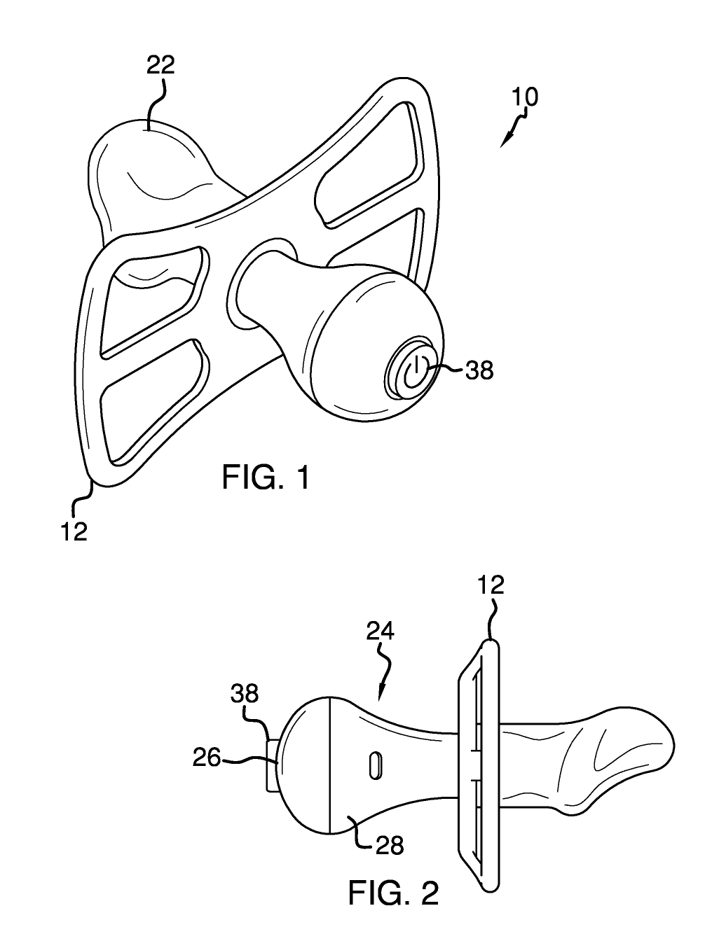

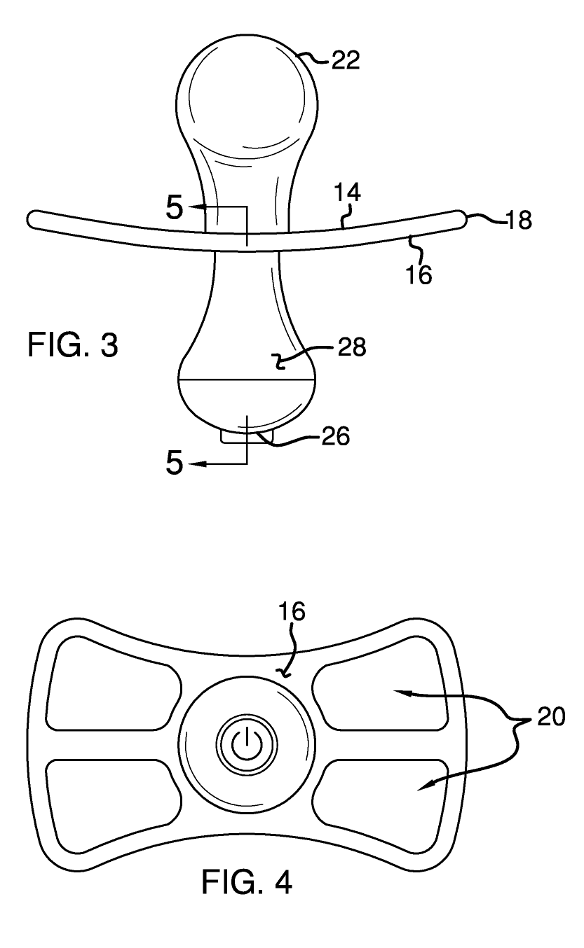

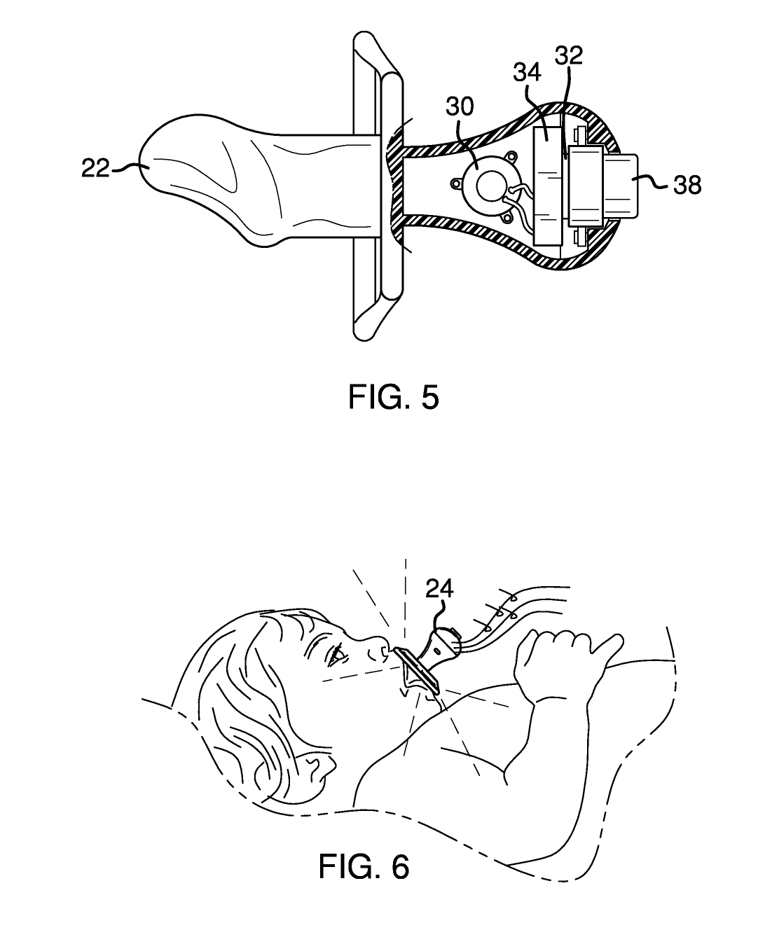

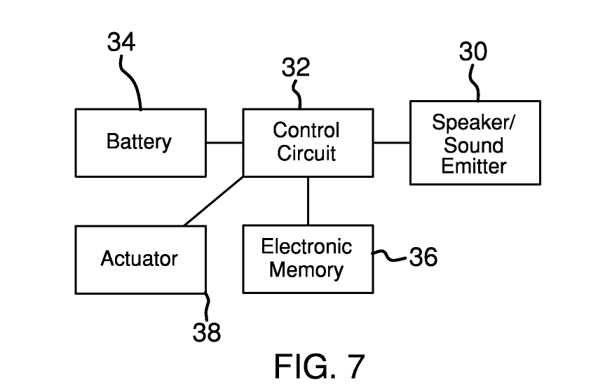

With reference now to the drawings, and in particular to FIGS. 1 through 7 thereof, a new pacifier device embodying the principles and concepts of an embodiment of the disclosure and generally designated by the reference numeral 10 will be described.

As best illustrated in FIGS. 1 through 7, the music playing pacifier assembly 10 generally comprises a wall 12 having a front side 14, a back side 16 and a perimeter edge 18. The wall 12 may be concavely arcuate on the front side 14 and may further have one or more apertures 20 extending therethrough.

A nipple 22 comprising a resiliently compressible material is attached to and extends away from the front side 14. The nipple 22 may be centrally located on the front side 14. While the nipple 22 may be comprised of generally conventional materials, the nipple 22 may further include a phosphorescent material. This will allow the nipple 22 to glow in the dark after being exposed to light and thus easier to locate when dropped.

A housing 24 is attached to the back side 16 and extends away therefrom. The housing 24 includes a distal end 26 with respect to the back side 16 and a perimeter wall 28 extending between the distal end 26 and the back side 16. The housing 24 may have a bulbous shape expanding in size from the wall 12 to the distal end 26 to facilitate gripping of the housing 24 as a handle for the assembly 10.

A sound emitter 30 is mounted within the housing 24 and a control circuit 32, positioned within the housing 24 as well, is electrically coupled to the sound emitter 30. The control circuit 32 may comprise a conventional micro switch or microprocessor. A battery 34 is mounted within the housing 24 and electrically coupled to the control circuit 32. An electronic memory 36 is electrically coupled to the control circuit 32. The electronic memory 36 stores at least one song thereon. The control circuit 32 audibly plays the at least one song with the sound emitter 30 when the control circuit 32 is actuated to a play condition.

An actuator 38 is mounted on the housing 24 and is electrically coupled to the control circuit 32. The actuator 38 may be positioned on the distal end 26 of the housing 24. The actuator 38 is engaged to actuate the control circuit 32 to the play condition. The term “engaged” is defined by being actuated in some manner such as pressing a button, moving a switch, or the like. The at least one song may include a plurality of songs. The control circuit 32 is programmed or designed such that the actuator 38 is engaged to cycle through the plurality of songs. Thus, if a user wants to hear the second of three songs, the actuator 38 is engaged two times. The actuator 38 may further be engaged a number of times equal to the number of songs plus one to actuate the control circuit 32 to an off condition. For example, if the number of songs is three songs, the actuator 38 is engaged four times to turn the assembly 10 off.

In use, the assembly 10 is used as a conventional pacifier for soothing an infant or toddler. However, the assembly 10 allows a person to cause a song, such as a lullaby, to be played. Examples of such are “Rock-a-bye Baby,” “Twinkle Twinkle Little Star,” and “Somewhere over the Rainbow.” The sound from such songs further sooth the infant to help lull them to sleep.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pacifier assembly comprising:
a wall having a front side, a back side and a perimeter edge;
a nipple comprising a resiliently compressible material being attached to and extending away from said front side;
a housing being attached to said back side and extending away therefrom, said housing including a distal end with respect to said back side and a perimeter wall extending between said distal end and said back side;
a sound emitter being mounted within said housing;
a control circuit being positioned within said housing and being electrically coupled to said sound emitter; and
an electronic memory being electrically coupled to said control circuit, said electronic memory storing at least one song thereon, said control circuit audibly playing said at least one song with said sound emitter when said control circuit is actuated to a play condition.

2. The pacifier assembly according to claim 1, wherein said nipple comprises a phosphorescent material.

3. The pacifier assembly according to claim 1, further including an actuator being mounted on said housing and being electrically coupled to said control circuit, said actuator being engaged to actuate said control circuit to said play condition.

4. The pacifier assembly according to claim 3, wherein said at least one song includes a plurality of songs, said actuator being engaged to cycle through said plurality of songs, said actuator being engaged a number of times equal to the number of songs plus one to actuate said control circuit to an off condition.

5. A pacifier assembly comprising:
a wall having a front side, a back side and a perimeter edge;
a nipple comprising a resiliently compressible material being attached to and extending away from said front side, said nipple being centrally located on said front side, said nipple comprising a phosphorescent material;
a housing being attached to said back side and extending away therefrom, said housing including a distal end with respect to said back side and a perimeter wall extending between said distal end and said back side;
a sound emitter being mounted within said housing;
a control circuit being positioned within said housing and being electrically coupled to said sound emitter;
an electronic memory being electrically coupled to said control circuit, said electronic memory storing at least one song thereon, said control circuit audibly playing said at least one song with said sound emitter when said control circuit is actuated to a play condition;
an actuator being mounted on said housing and being electrically coupled to said control circuit, said actuator being engaged to actuate said control circuit to said play condition; and
said at least one song including a plurality of songs, said actuator being engaged to cycle through said plurality of songs, said actuator being engaged a number of times equal to the number of songs plus one to actuate said control circuit to an off condition.
